(19) United States
(12) Patent Application Publication
(10) Pub. No.: US 2012/0200378 A1
(43) Pub. Date: Aug. 9, 2012

(54) Self Aligning Magnetic Linking System

(76) Inventor: Tom Shannon, New York, NY (US)

(21) Appl. No.: 13/020,241

(22) Filed: Feb. 3, 2011

(51) Int. Cl. H01F 7/02

(52) U.S. Cl. 335/285

(57) ABSTRACT

Magnetically linkable objects and methods for fabricating the same are provided. One of the object may include a cavity and a magnet located within the cavity. The cavity and magnet are configured such that the magnet may rotate within the cavity when it is brought within close proximity to another magnet. This ensures that the magnet within the cavity will always attract to the other magnet.

### FIELD OF THE INVENTION

The invention relates generally to magnets and more particularly to structures which can be selectively attached and detached using magnets.

### BACKGROUND OF THE INVENTION

Presently, permanent magnets have 2 poles (south and north). When 2 south poles or 2 north poles are aligned the magnets repel each other. When a south pole is aligned with a north pole, however, the magnets attract each other. When two magnets are randomly placed near each other they will tend to orient themselves to attraction as this is the dominant force for permanent magnets.

For many years people have been using the attracting and repelling properties of magnets to create toys, models, jewelry and other devices which can be selectively connected and separated. For example, toy trains exist where the cars link together using magnetic attraction. To assure that all of the cars can attach to all of the other cars, one end of each car is affixed with a south pole facing magnet and the other end is affixed with a north pole facing magnet. In this way the front of each car is attracted to the rear of each other car. Thus, if one orients the cars properly, a train can be created. However, if the cars are oriented incorrectly they will push apart.

Another example of a toy that employs magnets for selective connectivity is the magnetic sticks and balls set. Each stick element is like the train cars in that one end has a south facing magnet and the other end has a north facing magnet. Thus, when properly oriented they link together and when improperly oriented they repel each other. The ball elements of the set are made of magnetic metal, but are not magnets. As a result, the orientation of the sticks to the balls is irrelevant as they will always connect.

While the above toys and similar products are useful and enjoyable, they are inefficient in that the elements must always be manually oriented to link together. Further, the elements will only link together in one orientation. It would be advantageous to provide objects that could be selectively linked together using magnets, regardless of the orientation of the objects. It may also be advantageous to provide objects wherein the objects all employ magnets and not simply magnetic elements such as a steel ball. It would also be advantageous to create such objects which do not require fixing magnets in specific permanent orientations within the objects.

### SUMMARY OF THE INVENTION

Embodiments of the invention provide apparatus and methods for selectively linking multiple objects using magnets regardless of the original alignment of the magnets.

Aspects of the invention may provide a magnetic object that includes a body that has at least one cavity and an outer surface. A magnet, which has multiple polarities, North and South is located within the cavity such that it is capable of rotating when it is placed proximal to another magnet. This rotational capability ensures that the magnet will attract to other magnets without the object or the magnet having to be manually oriented relative to the other magnet.

Aspects of the invention may provide a method of creating a magnetic object that includes forming a body that has a cavity. The body may be formed, at least in part, from a flexible material. The cavity has an opening, which is at least partially covered by the flexible material of the body, but with at least a small opening remaining to allow passage of a magnet into the cavity. The method also includes forcing a magnet, which is larger than the size of the opening that is not covered by the flexible material, into the cavity. The cavity should be sufficiently large to allow the magnet to rotate when it is placed proximal to another magnet.

Aspects of the invention may provide a system of magnetic objects which include multiple objects and multiple magnets. At least one magnet is connected to one of the objects in such a way that it is capable of rotating relative to that object. At least one other magnet is connected to a different object. When the two objects are brought together they are selectively linkable by the magnets.

### BRIEF DESCRIPTION OF THE DRAWINGS

For a better understanding of the invention, reference is made to the following description, taken in conjunction with the accompanying drawings, in which like reference characters refer to like parts throughout, and in which:

FIGS. 1a-f illustrate various shaped magnets set in a cavity in accordance with one or more embodiments of the invention;

FIG. 2 is an illustration of a spherical form having magnets set in cavities at locations on the sphere resembling a tetrahedron in accordance with one or more embodiments of the invention;

FIG. 3 is an illustration of 3 spherical apparatus, each having 2 magnets set in cavities at locations on opposite sides of the sphere, linked together by the magnets in accordance with one or more embodiments of the invention;

FIG. 4 is an illustration of 9 spherical apparatus, each having 4 magnets individually set in cavities at locations separated by 90 degrees along an equator of the sphere, linked together by the magnets in accordance with one or more embodiments of the invention;

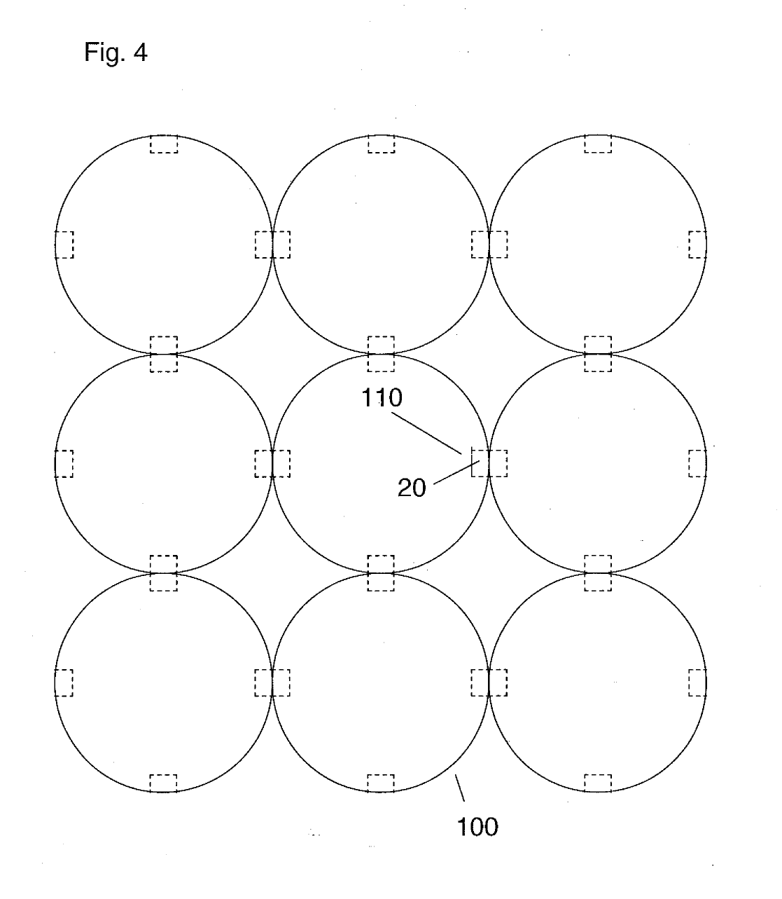

FIG. 5 is an illustration of an apparatus configured for selectively receiving one or more magnets in accordance with one or more embodiments of the invention;

FIG. 6 is an illustration of a magnet set in a cavity in accordance with one or more embodiments of the invention, wherein the cavity is configured to selectively mate with the apparatus of FIG. 5;

FIG. 7 illustrates an alternate embodiment of FIG. 6;

FIG. 8 illustrates another alternate embodiment of FIG. 6;

FIG. 9 illustrates another alternate embodiment of FIG. 6 and,

FIG. 10 illustrates a spherical apparatus having multiple magnets connected together within the sphere and capable of moving relative to the sphere.

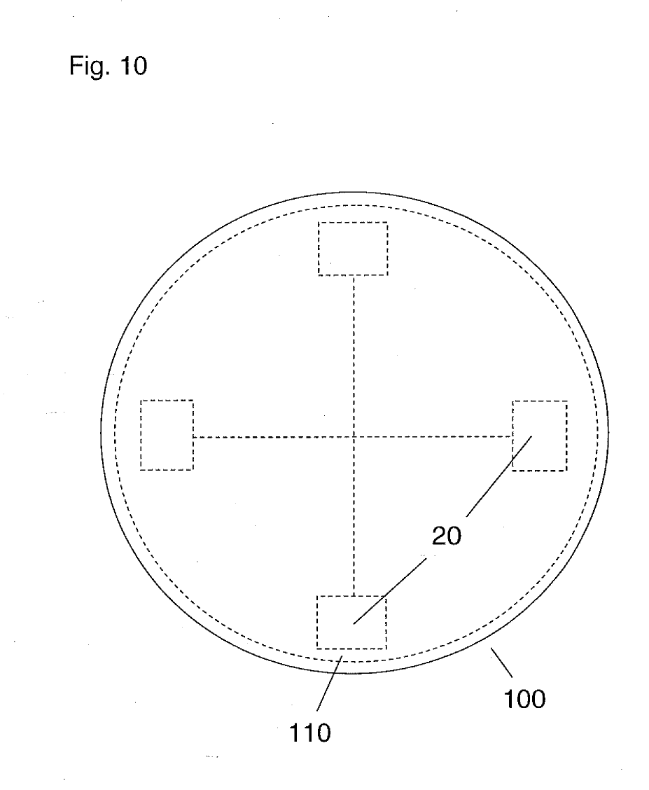

The invention will next be described in connection with certain illustrated embodiments and practices. However, it will be clear to those skilled in the art that various modifications, additions and subtractions can be made without departing from the spirit or scope of the claims.

### DETAILED DESCRIPTION OF THE INVENTION

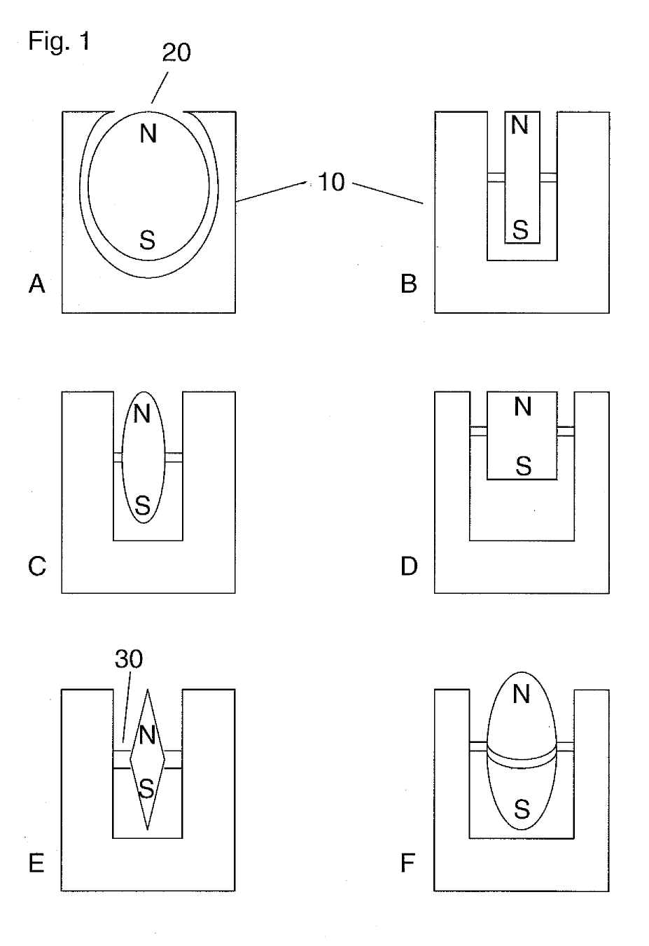

Embodiments of the invention provide a magnetic apparatus 100 (also referred to as a form, body or object) which includes at least one self orienting magnet 20. The object 100 may be a made from a bouncy material, a flexible material, a rigid material or a combination of materials. It may be opaque, transparent, translucent or a combination of these things. The magnet 20 enables the object 100 to always attract to, among other things, another magnetic apparatus 100 that has either a self orienting magnet 20 or a fixed magnet without the need to manually arrange the polarities of the magnets 20. While many types of magnets and many shapes of magnets are contemplated, for ease of explanation, the majority of the remainder of the description shall be limited to spherical Neodymium magnets. While the description may be limited the invention is not. Those skilled in the art will recognize that the description is applicable to other shapes and types of magnets as well without departing from a scope of the invention. By way of a non-exhaustive list of examples, the magnets could be cylindrical, cubed, egg shaped, etc (See FIG. 1a-f). Also the magnets need not be made from Neodymium, although Neodymium magnets are plentiful and inexpensive.

Aspects of the invention provide a magnet 20, which is set in a cavity/socket/cell 10 (these terms will be used interchangeably herein) of an object 100 such that the magnet 20 is free to rotate between its north and south polarities. As illustrated in FIGS. 1a-f, the magnet 20 could be free floating (i.e. not connected) in the socket (1a), it could include a rotational axis or rod(s) about which it is free to rotate (1b-1e) or it could be attached to or encased in an element that enables it to freely rotate between polarities (e.g. 1f). Those skilled in the art will recognize that other conventional methods may exist which would allow the magnet 20 to rotate between polarities and that those configurations are considered within the scope of the invention as well but do not require further description herein.

The cell 10 may be a separate unit that is fixed within an object 100 or it may be formed as part of the object itself. The magnet 20 within the cell 10 enables the object 100 to link to another object 100. Those skilled in the art will recognize that the outer edge of the cell 10 may be flush with, recessed in or protruding from the surface of the object 100. It is also possible, but not required that the opening to the cell 10 be covered for aesthetic purposes (not illustrated). It is also possible to provide an outer shell (not shown) that covers the entire object 100. The object 100 may be configured to move relative to the shell or it may be configured to be stationary relative to the shell.

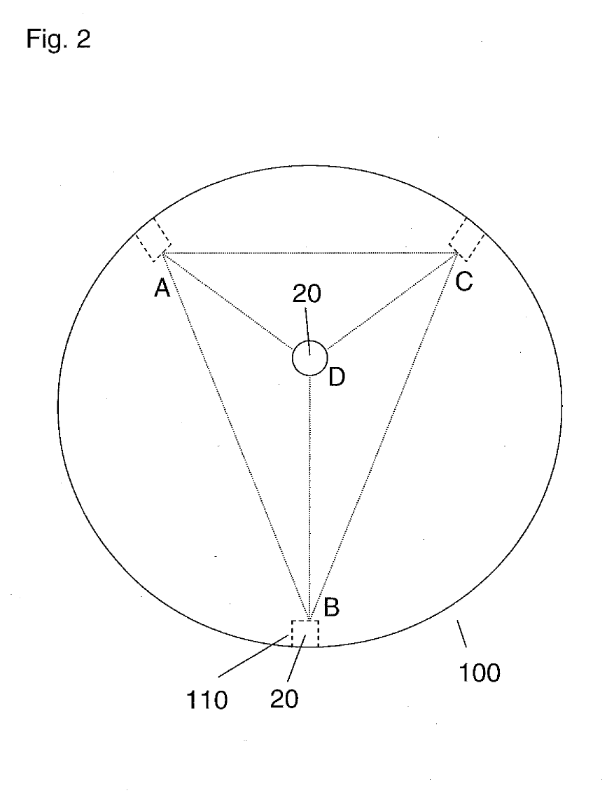

It is preferred but not required that, when multiple magnets 20 are employed in the same object 100, they be configured such that the attracting forces of the multiple magnets 20 do not interfere with each other. In other words, only an intended magnet 20 will attract a second object. The two objects will link together only at the intended magnet 20 rather than at a different magnet 20, which may also be located on the object 100. In such a configuration this will be true even if the other magnet 20 on the object 100 is physically proximal the intended linking magnet 20. A manner in which this capability may be assured in a sphere is by fixing the magnet sockets 10 just inside and tangent to convex surfaces of the object 100. For example, the magnet sockets 10 may be distributed over the surface of a sphere 100 with four magnet sockets 10 spaced in the pattern of the four vertices of a tetrahedron over the surface of the sphere (FIG. 2). Dotted lines AB, AC, AD, BC BD and CD in FIG. 2 are not part of the invention. Instead they are merely illustrating that the magnet sockets 110 form a tetrahedron shape. Spheres of this design placed in proximity tend to self-organize into the regular three-dimensional lattice pattern of carbon atoms in a diamond crystal. Placing magnet sockets 10 in various numbers and patterns over the surfaces of spheres enables researchers to rapidly explore the bonding dynamics and architectures of many molecular possibilities.

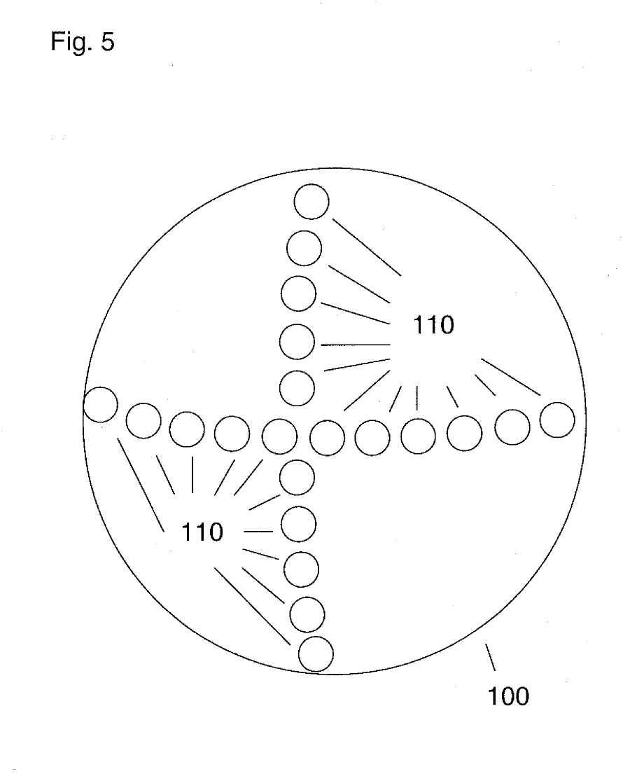

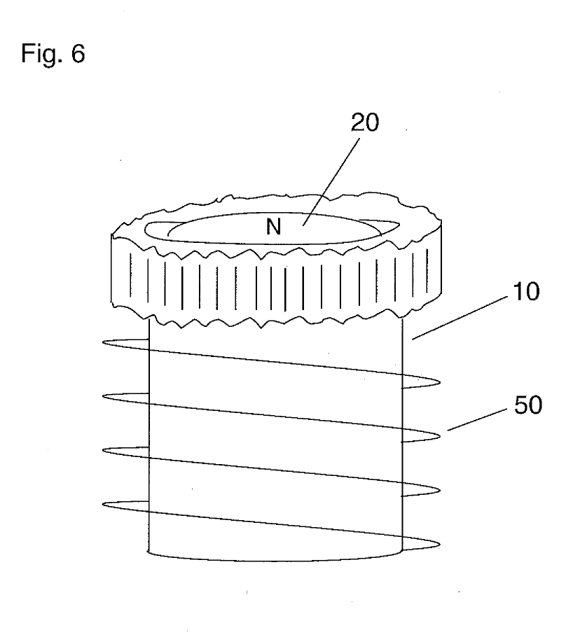

The free rotation magnet socket system provided by the invention can be applied to many types and shapes of objects. Sockets 110 set into non-magnetic convex forms 100 are best suited to block magnetic attachment of building elements from anywhere but the intended link sites. The smooth surrounding of the magnet socket 10 helps guide the attracting magnets of the two objects 100 into contact while at the same time, shielding the magnet 20 from attaching to a wrong position. By limiting the attachment of objects 100 to a specific nodal pattern the objects 100 can, by natural tendency, assemble into strong, specifically engineered architectures. For example, balls with two magnet sockets 10 on directly opposite sides can only assemble into lines (FIG. 5), balls with four magnet sockets 10 evenly spaced around their equators self-organize into flat planes (FIG. 6), balls with six magnet sockets 10 separated by 90 degree in the XYZ coordinates (e.g. 4 four magnet sockets 10 evenly spaced around one equators with two additional magnet sockets 10 evenly spaced 90 degrees from each of those magnet sockets) self-assemble into volumes (not illustrated). A potential, but non-limiting use for this magnetic linking system is to assemble human and animal figures with magnet sockets placed on the body, limb joints, head, etc.

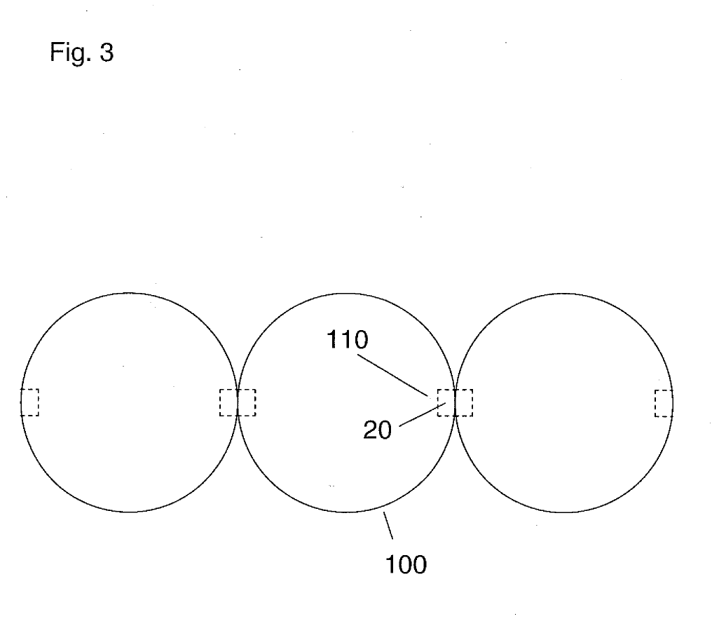

As illustrated in FIG. 5, embodiments of the invention may provide a form 100 having multiple locations 110 for selectively attaching the magnet sockets 10. For example, FIG. 3 illustrates a golf ball shaped form 100 wherein the dimples of the golf ball are configured to receive a magnet socket 10 such as that illustrated in FIG. 6, 7 or 8. Those skilled in the art will recognize that the mating between magnet socket 10 and form 100 may be a screw fitting (FIG. 6), a snap-fitting, or any other conventional fitting which allows for selective connecting and disconnecting between the form and magnet socket.

In the configuration illustrated in FIG. 5 the user has the option to selectively fit the form 100 with one or more magnet sockets 10 in a variety of different locations 110. This provides a versatile form in that may be configured to meet the needs or desires of the user. While a golf-ball shaped form 100 has been illustrated, those skilled in the art will recognize that the form 100 could be any shape and could include a single receiving location 110 or multiple receiving locations 110 without departing from a scope of the invention.

In the magnet socket configuration illustrated in FIG. 6, the magnet socket 10 is provided with a male screw thread 50. Thus the receiving locations 110 in the form 100 would be provided with female screw threads or grooves (Not illustrated but well known to those skilled in the art). While not typical, the threading could be reversed with the locations 110 on the form 100 being provided with a male screw thread 50 and the magnet socket 10 being provided with the female portion.

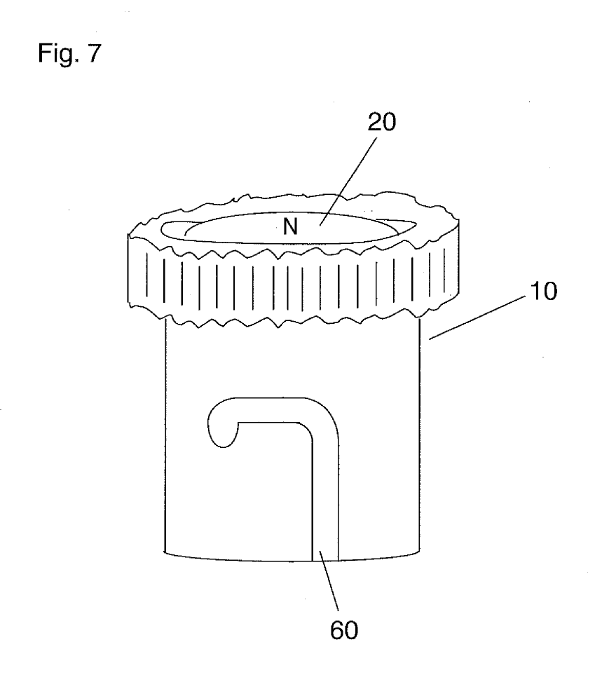

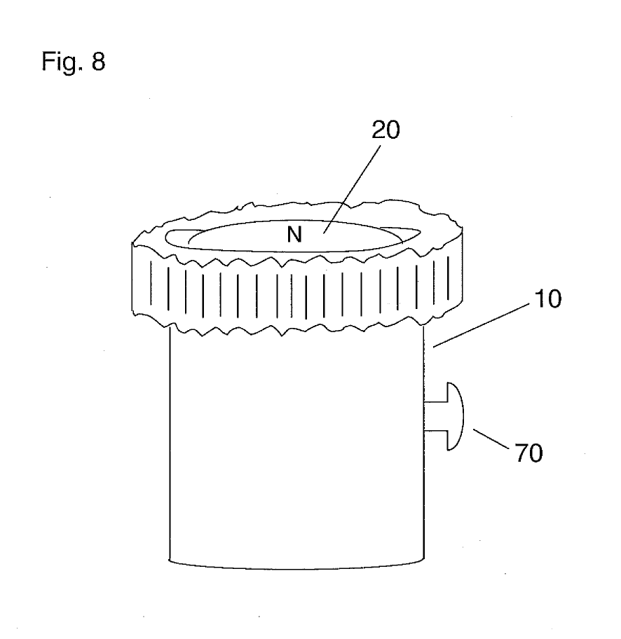

In the magnet socket 10 configuration illustrated in FIG. 7, the magnet socket 10 is provided with a groove 60 in the shape of an upside down J. While only 1 groove 60 is shown, the magnet socket 10 could be provided with multiple grooves 60 without departing from a scope of the invention. Further, while a generally J shaped groove is illustrated other shapes can be employed without departing from a scope of the invention. In this configuration, the connecting location 110 in the form 100 may be fitted with a protrusion or tongue (not shown but well known in the art), that is configured to mate with the groove 60 such that when the magnet socket 10 is inserted into the form and twisted it locks into place. To this end, a non-magnetic urging member such as a spring or some similar element may be included at the bottom of the magnet socket 10 or at the bottom of the cell 110 that receives the magnet socket 10 to urge the magnet socket 10 into a locked position. The urging member is not illustrated, but is well known in the art and thus requires no further explanation. As illustrated in FIG. 8, the mating configuration between the magnet socket 10 and the form 100 could be reversed with the protrusion 70 being located on the magnet socket 10 and the J shaped groove being located on the cell 110 that receives the magnet socket 10. The difference between this configuration and that of FIG. 7 is that in the FIG. 8 configuration, the J shaped groove would be right side up as opposed to upside down.

In the configurations of FIGS. 7 and 8, the user connects a magnet socket 10 to the form 100 by pushing it into the receiving location 110 and twisting the magnet socket 10 until it is in the correct location (e.g. until it can not turn any more). At this point the magnet socket 10 can be release and the urging member will secure the magnet socket 10 to the form 100 by urging the protrusion into the smaller portion of the J shape. To remove the magnet socket 10 from the form 100 force is applied to the magnet socket 10 to overcome the urging force of the urging member, the magnet socket 10 is twisted in the opposite direction from the direction used to attach the magnet socket 10 and then it is removed.

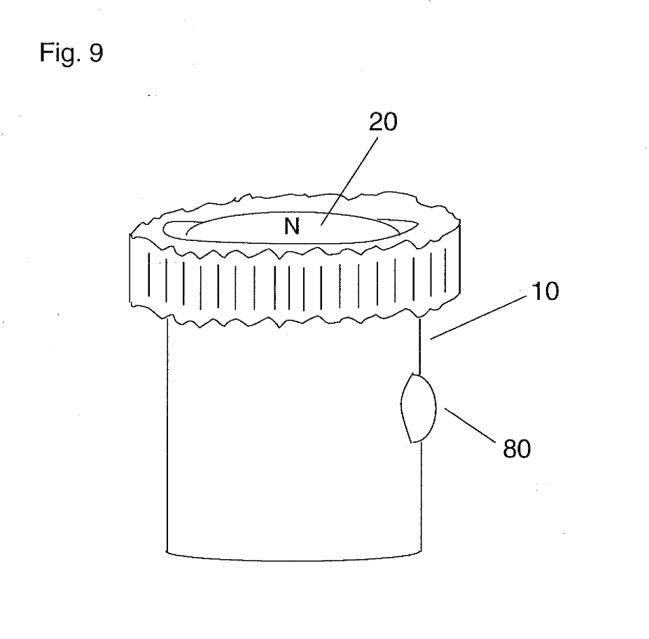

The magnet socket 10 configuration illustrated in FIG. 9 is provided with a protrusion 80 such as a ball bearing or a bead that is urged by an urging device, such as a spring or some other conventional urging device, in a direction outward from the magnet socket 10. The protrusion 80 is preferably capable of being recessed into the magnet socket 10 so that its outer edge lies within the same plane as that of the magnet socket 10. Those skilled in the art will recognize that if the protrusion 80 recesses less than all of the way into the same plane as the magnet socket 10 or further than the plane that it would still fall within a scope of the invention. Being able to recess the protrusion 80 allows the magnet socket 10 to be inserted into the receiving area 110 of the form 100. While only 1 protrusion is shown in FIG. 9, the magnet socket 10 may be provided with multiple protrusions 80 without departing from a scope of the invention. In this configuration, the connecting location 110 in the form 100 may be fitted with one or more recesses (not illustrated but apparent to one skilled in the art) along the wall of the receiving location 110 that is the negative of the protrusion 80. For example, if the protrusion is a sphere the recess(es) could be a concave hemisphere. This would provide a locking type mechanism when the protrusion 80 mates with the recess, since the urging member would tend to maintain the protrusion 80 in contact with the recess. A conventional release mechanism could be provided for releasing the urging pressure from the protrusion 80 which would allow it to escape from the recess when it is desired to remove the magnet socket 10 from the form 100.

Those skilled in the art will recognize that with most of the selective locking mechanisms, the number of elements located on the magnet socket 10 need not be the same as the number in the connecting location 110 within the form 100. The number of locking elements on the magnet socket 10 could be fewer than those in the connecting location 110 within the form 100 or greater and still fall within a scope of the invention. By way of a non-limiting example, there could be a single protrusion 80 on the magnet socket 10 and multiple recesses on the wall of the connecting location in the form. This one to many (or fewer to many as the case may be) configuration provides a more versatile locking mechanism since the mating need not always be in exactly the same location/position. Further, while it is preferable that all of the locking mechanisms for the form 100 illustrated in FIG. 5 should be identical there is no requirement for such uniformity. It is possible that some receiving locations 110 will be fitted for one type of locking mechanism while others may be configured for different types of locking mechanisms.

Thus it is seen that apparatus and methods are provided for creating self orienting magnetic linking objects. Although particular embodiments have been disclosed herein in detail, this has been done for purposes of illustration only, and is not intended to be limiting with respect to a scope of the claims, which follow. In particular, it is contemplated by the inventor that various substitutions, alterations, and modifications may be made without departing from a spirit and scope of the invention as defined by the claims. For example, the form 100 could take on any shape and have any number of receiving locations 110. The object 100 could include at least one self- orienting magnet and any combination of stationary magnets and/or magnetic elements that are not magnets. The magnet 20 could be multiple magnets 20 linked together such that the multiple magnets 20 may move as a single unit and/or the magnets 20 could each rotate individually. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

What is claimed is:

1. A magnetic apparatus comprising:
a body having a cavity and an outer surface, and;
a magnet, having multiple polarities, said magnet being located within said cavity such that said magnet may rotate when said magnet is placed proximal another magnet to ensure that said magnet will attract to said another magnet without having to manually orient said magnet.

2. The magnetic apparatus according to claim 1 further comprising:
said body having a plurality of cavities, and;
a stationary magnet, having a plurality of polarities, being located in one of said plurality of cavities, wherein said stationary magnet has its polarities fixed relative to said outer surface.

3. The magnetic apparatus according to claim 1 wherein said cavity is located below said outer surface of said body.

4. The magnetic apparatus according to claim 1 wherein said cavity is located partially below said outer surface of said body and wherein said outer surface includes an opening to said cavity.

5. The magnetic apparatus according to claim 4 wherein said body is flexible and said opening to said cavity is smaller than said magnet; wherein said magnet may be inserted into said cavity through said opening by applying physical force to said magnet.

6. The magnetic apparatus according to claim 1 said magnet further comprising an axel about which said magnet rotates.

7. The magnetic apparatus according to claim 1 further comprising a socket surrounding said magnet, wherein said magnet may rotate within said socket, said socket configured to mate with said cavity in said body.

8. The magnetic apparatus according to claim 7 wherein said socket is configured to selectively mate with said cavity.

9. The magnetic apparatus according to claim 8 wherein said selective mating is accomplished through a threaded engagement.

10. The magnetic apparatus according to claim 8 wherein said selective mating is accomplished through a snap fit engagement.

11. The magnetic apparatus according to claim 8 wherein said selective mating is accomplished through a tongue and groove engagement.

12. The magnetic apparatus according to claim 1 wherein said magnet comprises a plurality of magnets coupled together, wherein each of said plurality of magnets is fixed in a particular polar orientation; and,
said plurality of magnets being configured to rotate as a single unit when said body is placed proximal another magnet to ensure that said magnet will attract to said another magnet without having to manually orient said plurality of magnets.

13. A method of creating a magnetic object comprising:
forming a body having a cavity, said body being made at least in part from a flexible material;
wherein said cavity has an opening and said opening is at least partially covered by said flexible material; and,
forcing a magnet into said cavity, wherein said magnet is larger than the size of the opening that is not covered by said flexible material; and, wherein said cavity is sufficiently large to allow said magnet to rotate when said magnet is placed proximal another magnet.

14. The method according to claim 13 further comprising:
moving another magnet into close proximity to said magnet such that said magnet rotates within said cavity to orient towards attracting said another magnet and wherein said flexible material maintains said magnet within said cavity.

15. A system of magnetic objects comprising:
a plurality of objects;
a magnet connected to one of said plurality of objects; wherein said magnet is capable of rotating relative to said object; and,
another magnet connected to at least another of said plurality of objects;
said object and said another object being selectively linkable by said magnets.

16. The system according to claim 15 wherein said another magnet is capable of rotating relative to said another object.

17. The system according to claim 15 wherein said another magnet is fixed in place relative to said another object.

18. The system according to claim 15 further comprising yet another magnet connected to said object and fixed in place relative to said object.
